(19) United States
(12) Patent Application Publication
(10) Pub. No.: US 2006/0239805 A1
(43) Pub. Date: Oct. 26, 2006

(54) Locking apparatus of truck with hoist

(75) Inventor: Koji Aono, Shizuoka-ken (JP)

Correspondence Address: BACON & THOMAS, PLLC, 625 SLATERS LANE, FOURTH FLOOR, ALEXANDRIA, VA, 22314, US

(73) Assignee: AONO CO., LTD., Shizuoka-ken (JP)

(21) Appl. No.: 11/360,382

(22) Filed: Feb. 24, 2006

(30) Foreign Application Priority Data
Apr. 22, 2005 (JP) 2005-124799

(51) Int. Cl. B60P 1/02

(52) U.S. Cl. 414/495

(57) ABSTRACT

For higher durability and easier assembly, a locking apparatus holding and releasing an ascended position of a hoist table, is structured such that engagement arms are connected to upper end portions of link arms connected to hoist table side of a parallel link mechanism to freely oscillate frontward, engagement bodies are provided in front end portions of the engagement arms, annular guide grooves guiding the engagement bodies in longitudinal and vertical directions are provided in side portion frames of a fork frame, a stopper walls having step shaped rear portions are provided in upper portions of the grooves, and front portions of the grooves are provided with check valves allowing the engagement bodies to pass through forward and guiding the passed engagement bodies to upper portion side of the guide grooves.

### TECHNICAL FIELD

The present invention relates to a locking apparatus of a truck with a hoist for lifting and carrying a box container in which small articles such as parts, foods or the like are contained.

### BACKGROUND ART

As a prior art, there has been a structure shown in FIGS. 8 to 10. In FIGS. 8 to 10, reference numeral 1 denotes a truck with a hoist, and reference numeral 2 denotes a frame thereof. The frame 2 is formed in a fork shape with an open front portion, by a pair of side portion frames 2a and 2a, which are apart from each other at the right and the left, and a cross frame 2b coupled to rear portions thereof (a right portion in FIG. 8), front wheels 3 and 3 are attached to front portions of the respective side portion frames 2a and 2a, and rear wheels (casters) 4 and 4 and a handle 6 are attached to both right and left end portions of the cross frame 2b.

A fork-shaped hoist table 5 is fitted to the frame 2 from the above so as to be movable upward and downward. The hoist table 5 is formed in a fork shape with an open front portion, by side portion hoist tables 5a and 5a covering the respective side portion frames 2a and 2a, and a rear portion hoist table 5b coupled to a rear portion thereof (a right portion in FIG. 8), the respective side portion hoist tables 5a and 5a are formed in an inverted-U shape in a cross section and cover upper surfaces and both right and left sides of the respective side portion frames 2a and 2a, and holders 5c and 5c protruding in opposing directions to each other (toward an inner side) are integrally coupled to lower ends of inner side walls thereof.

The hoist table 5 is moved upward and downward by an actuating apparatus 10 as shown in FIGS. 9 and 10. The actuating apparatus 10 is constituted by a parallel link mechanism 12 and a locking apparatus 20. The parallel link mechanism 12 is structured such that a front portion link arm 12a and a rear portion link arm 12b are arranged in a front portion and a rear portion of each of the side portion frames 2a and 2a and each of the side portion hoist tables 5a and 5a respectively toward the same longitudinal direction, front ends thereof are rotatably connected to the respective side portion hoist tables 5a and 5a by front portion pins P1 and P1, and rear ends thereof are rotatably connected to the respective side portion frames 2a and 2a by rear portion pins P2 and P2.

Actuating levers 13 and 13 are integrally connected to rear ends of the respective rear portion link arms 12b. The respective actuating levers 13 and 13 are extended rearward as shown in FIG. 8, and rear ends thereof are connected to each other by a step bar 13a. A user rotates the rear portion link arms 12b upward at an angle of about 45 degree around the rear portion pins P2 by stepping on the step bar 13a. Accordingly, the hoist table 5 is moved upward in parallel to the frame 2, and the holders 5c thereof are lifted from a ground surface.

A locking apparatus 20 for holding and releasing the ascended position of the hoist table 5 is provided in each of the rear portion link arms 12b. In particular, as shown in FIG. 10, an engagement arm 16 is rotatably connected to the front portion pin P1 of the rear portion link arm 12b so as to be extended frontward(a left side in FIG. 10), and an engagement body 17 constituted by a roller is attached to a front end of the engagement arm 16. Further, a rear end of a coil spring (an elastic body) 18 is locked to a front end of the engagement arm 16, the coil spring 18 is pulled frontward, and a rear end thereof is locked to a bracket 19 fixed uprightly to a bottom portion of the side portion frame 2a positioned in a front side of the rear portion link arm 12b.

The locking apparatus 20 is attached to a side surface of the side portion frame 2a, and in the middle of a locus of the engagement body 17 moving in accordance with the rotation of the rear portion link arm 12b. The locking apparatus 20 has a regulating body 21 regulating a rearward movement of the engagement body 17 in the process, and a stopper 22 inhibiting the regulated engagement body 17 from being moved frontward (being returned) and having a C shape in a side view. In other words, as shown in FIG. 10, when stepping the actuating lever 13 so as to rotate the rear portion link arm 12b upward, the engagement arm 16 is rotated upward on the basis of reaction force of the coil spring 18 as shown by a single-dot chain line in FIG. 10, and the engagement body 17 comes into collision with the regulating body 21 in a state of being lifted upward at a predetermined amount. If the stepping down of the actuating lever 13 is stopped in this state, the rear portion link arm 12b is rotated downward on the basis of gravitational force of the hoist table 5.

In this case, since the front portion pin P1 of the rear portion link arm 12b is yet positioned at the upper side in comparison with an initial position, and the engagement arm 16 is rotationally energized upward on the basis of the reaction force of the coil spring 18, the engagement body 17 is moved to the upper side than the regulating body 21 so as to be moved frontward at a time when the engagement body 17 is moved apart from the regulating body 21 so as to be moved frontward (be returned). Further, the engagement body 17 is caught by an engagement concave portion 22a of the stopper 22 as shown by a two-dot chain line in FIG. 10, and is inhibited from being moved frontward (being returned), whereby the hoist table 5 is inhibited from descending, and the hoist table 5 is in a state of being kept lifted from the ground surface. Accordingly, it is possible to move a box container 25 supported to the holder 5c of the hoist table 5.

In the state mentioned above, when stepping the actuating lever 13 again so as to rotate the rear portion link arm 12b further upward, the engagement body 17 is moved away from the engagement concave portion 22a of the stopper 22 as shown by a broken line in FIG. 10, and is moved to the upper side of the stopper 22 via the engagement arm 16 and the coil spring 18. Next, when stopping the stepping down of the actuating lever 13, the rear portion link arm 12b is rotated downward on the basis of the gravitational force of the hoist table 5, whereby the engagement body 17 moves frontward while rolling on an upper surface of the stopper 22, and is returned to the initial position. Accordingly, it is possible to mount the box container 25 at a predetermined position and it is possible to move the truck 1 away from the box container 25.

In the conventional structure mentioned above, since the coil spring 18 is used in the locking apparatus 20 for holding and releasing the ascended position of the hoist table 5, an emergency measure can not be taken in the case that the coil spring 18 is broken, so that a work hindered. Further, a lot of man-hour is required for assembling. Furthermore, if a reaction force of the spring is lowered, it is necessary to replace the spring, and a lot of man-hour is required for maintenance and inspection.

Patent Document 1 Japanese Utility Model Publication No. 4-10144

### DISCLOSURE OF THE INVENTION

### Problem to be Solved by the Invention

An object of the present invention is to obtain a locking apparatus of a truck with a hoist which has a high durability of the locking apparatus and is easily assembled.

### Means for Solving the Problem

In order to achieve the object mentioned above, the present invention is structured as follows. In accordance with a first aspect of the present invention, there is provided a locking apparatus of a truck with a hoist comprising a fork-shaped frame made by connecting rear end portions of a pair of side portion frames apart from each other at the right and the left via a cross frame and provided with wheels in lower portions, a hoist table covering at least inner sides and upper surfaces of the respective side portion frames and an actuating apparatus provided with a parallel link mechanism holding the hoist table horizontally and moving the hoist table upward and downward with respect to the frame, actuating levers actuating the parallel link mechanism, and a locking apparatus holding and releasing an ascended position of the hoist table, so as to move the hoist table upward and downward with respect to the frame, wherein the locking apparatus has engagement arms connected to upper end portions of the link arms, which are connected to hoist table side of the parallel link mechanism, so as to freely oscillate frontward, engagement bodies provided in front end portions of the engagement arms, annular guide grooves provided in the side portion frames to guide the engagement bodies in a longitudinal direction and a vertical direction stopper walls provided in upper portions of the guide grooves, and having rear portions extended downward in a step shape and check valves provided in front portions of the guide grooves to allow the engagement bodies to pass through forward and guide the passed engagement bodies to upper portion side of the guide grooves.

In accordance with a second aspect of the present invention, there is provided a locking apparatus of a truck with a hoist, wherein the guide grooves are formed in independent plates from the side portion frames, and the plates are fixed to side surfaces of the side portion frames.

### EFFECTS OF THE INVENTION

In accordance with the first aspect of the present invention, at an initial time when the parallel link mechanism is actuated to a downward movement side on the basis of a dead weight of the hoist table, the engagement arms of the locking apparatus are pressed frontward by the upper end portions of the link arms of the parallel link mechanism, the engagement bodies move to the front end side of the guide grooves after opening the check valves so as to pass through these portions, and the check valves are thereafter closed on the basis of a dead weight. When positioning the hoist table to the lower surface side of the box container in this state and stepping down (operating) the actuating lever so as to actuate the parallel link mechanism to the ascending side, the hoist table is moved upward from the frame so as to lift the box container from the ground surface.

On the other hand, in accordance with the operation of the parallel link mechanism to the ascending side, the engagement arms of the locking apparatus are pulled rearward by the upper end portions of the link arms of the parallel link mechanism, and the engagement bodies comes into collision with the upper stages of the stopper walls provided in upper portion side of the guide grooves after being guided to the upper portion side along the upper surfaces of the check valves. If the stepping down of the actuating levers is released in this state, the hoist table is going to descend on the basis of a weight of the box container and accordingly the parallel link mechanism is going to be moved in a descending direction, however, the engagement bodies come into collision with (is engaged with) the lower stage of the stopper wall at this time so as to inhibit the parallel link mechanism from moving downward, thereby inhibiting the hoist table from descending, and making the box container in a state of being kept lifted from the ground surface, so that it is possible to move the box container by the truck.

Next, the engagement bodies move apart from the lower stage of the stopper wall and comes down to the front portion side lower portion of the guide groove on the basis of a dead weight, by stepping down the actuating lever so as to move the parallel link mechanism to further the ascending side, at a time of unloading the box container from the truck. If the stepping down of the actuating lever is stopped in this state, the parallel link mechanism is moved in the descending direction on the basis of the weights of the box container and the hoist table. Accordingly, the engagement bodies are moved frontward in the lower portion side of the guide grooves, open the check valves so as to pass through these portions, and thereafter move to the front end side of the guide grooves. Thereafter, the check valves are closed on the basis of the dead weight and become in the initial state, and the box container is grounded so as to make it possible to remove the truck from the box container. Accordingly, the invention in accordance with the first aspect can hold and release the ascended position of the hoist table without using any spring, and thus assembling becomes easy as well as durability is enhanced.

In the invention in accordance with the second aspect, since the guide grooves are formed in the independent plates from the side portion frames, and the plates are fixed to the side surfaces of the side portion frames, it is possible to easily form the guide grooves.

### BRIEF DESCRIPTION OF THE DRAWINGS

FIG. 1 is a perspective view showing an embodiment in accordance with the present invention;

FIG. 2 is a partly cross sectional plan view in accordance with the present invention;

FIG. 3 is a cross sectional view along a line III-III in FIG. 2 showing a state of a hoist table being lowered;

FIG. 4 is a cross sectional side view showing a state of the hoist table being lifted in accordance with the present invention;

FIG. 5 is a cross sectional view showing a state of the hoist table being kept lifted in accordance with the present invention;

FIG. 6 is a cross sectional view showing a state of an locking apparatus being disengaged in accordance with the present invention;

FIG. 7 is a cross sectional view of a main portion showing a state of the locking apparatus being returned to an initial position in accordance with the present invention;

FIG. 8 is a perspective view showing a prior art;

FIG. 9 is a cross sectional side view along a line IX-IX in FIG. 8 showing a state of a hoist table being lowered in accordance with the prior art; and

FIG. 10 is an explanatory view showing a state of operation of a locking apparatus in accordance with the prior art.

### BEST MODE FOR CARRYING OUT THE INVENTION

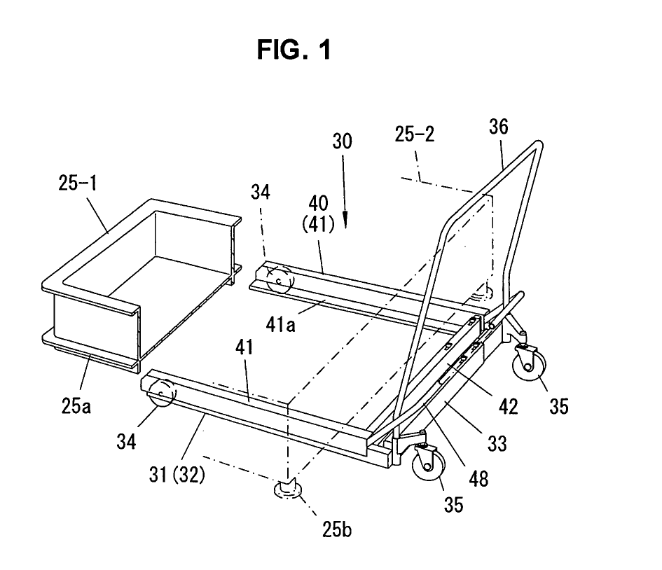

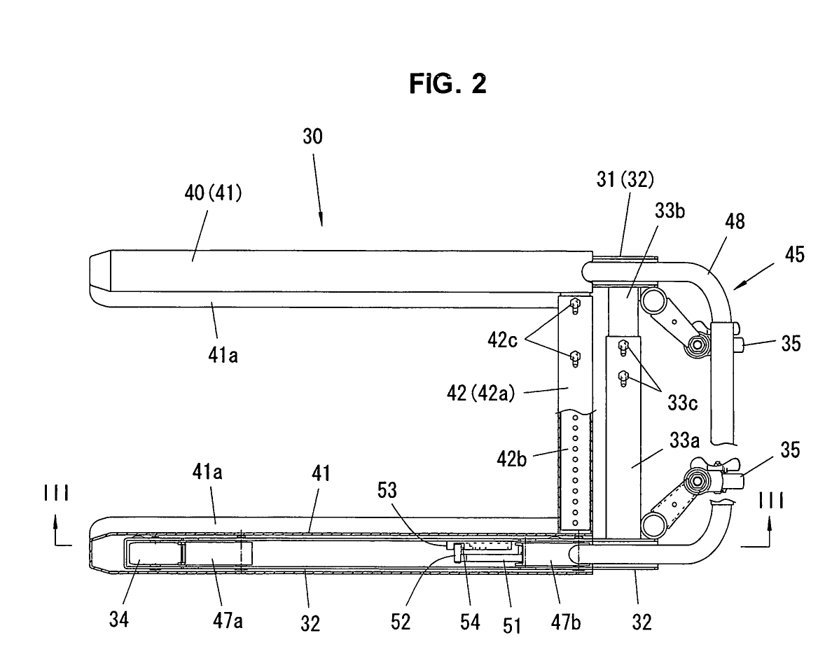

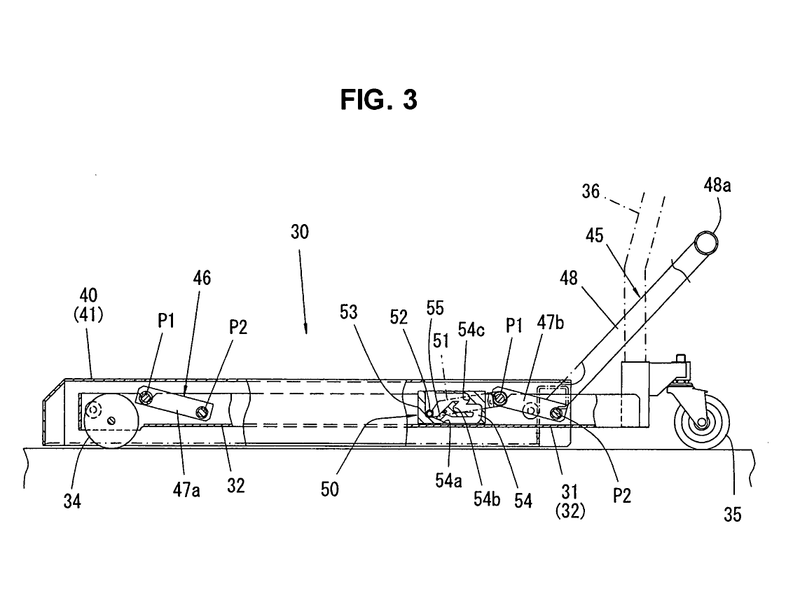

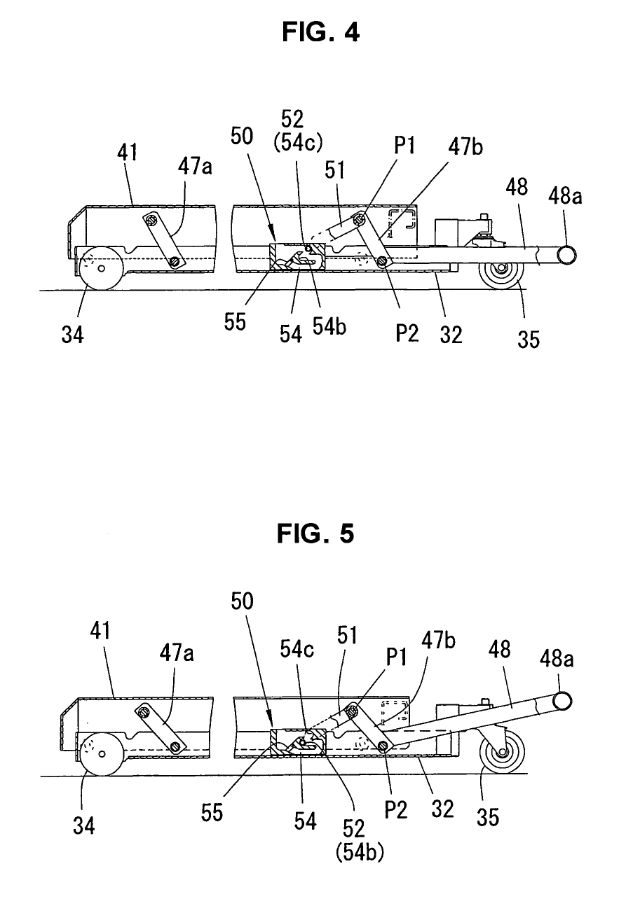

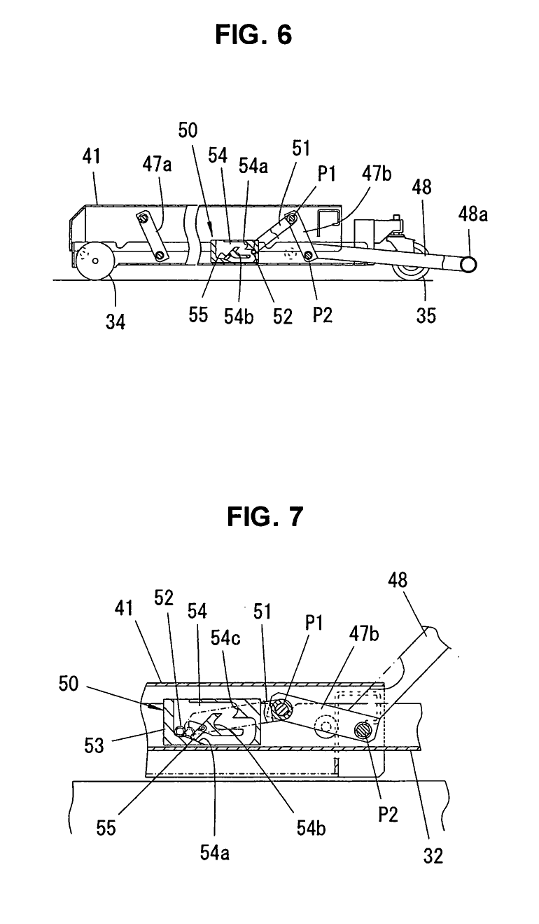

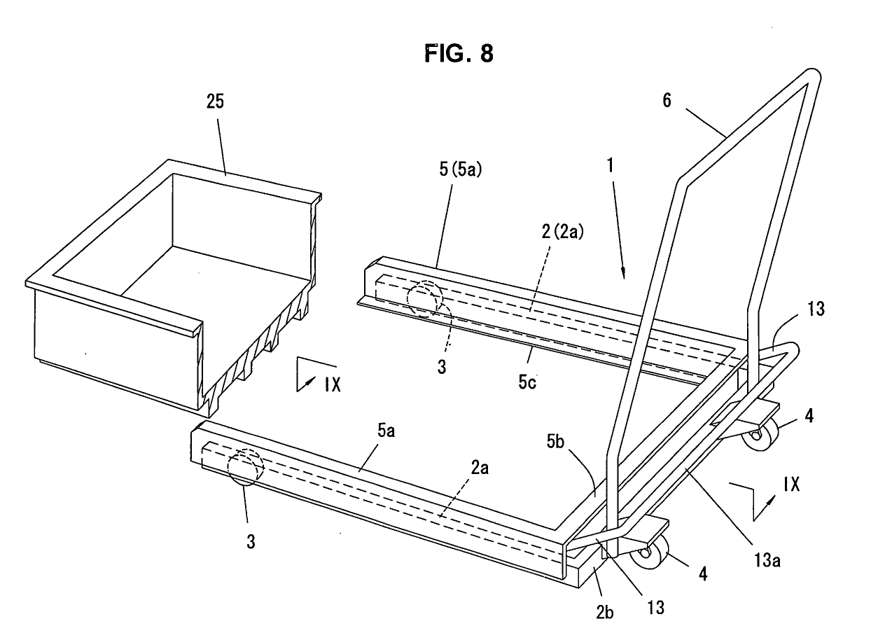

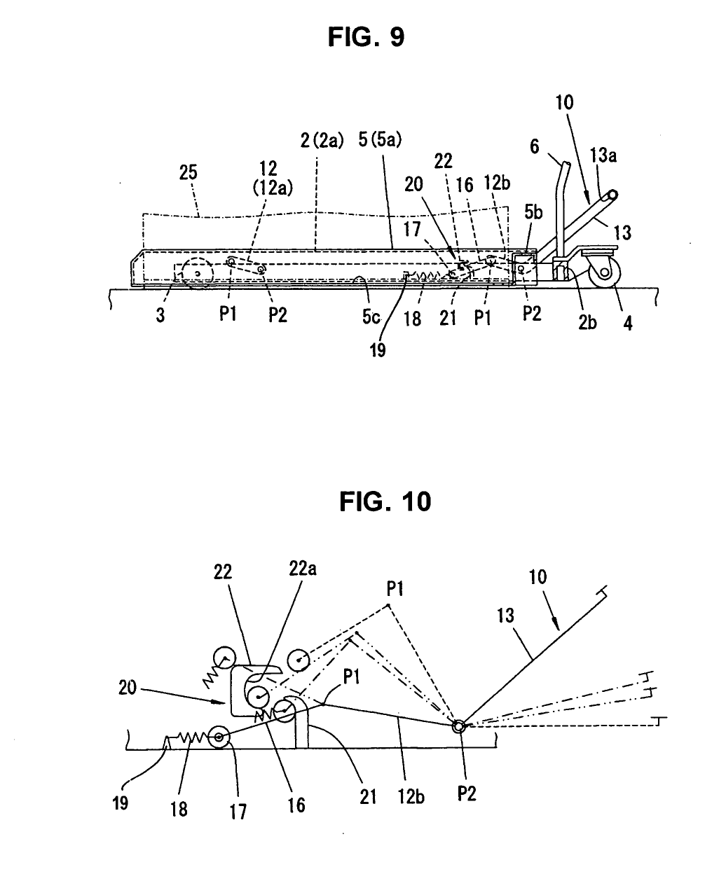

A description will be given of an embodiment in accordance with the present invention with reference to the accompanying drawings. In the drawings, FIG. 1 is a perspective view showing an embodiment in accordance with the present invention, FIG. 2 is a partly cross sectional plan view, FIG. 3 is a cross sectional view along a line III-III in FIG. 2 showing a state of a hoist table being lowered, FIG. 4 is a cross sectional side view showing a state of the hoist table being lifted, FIG. 5 is a cross sectional view showing a state of the hoist table being kept lifted, FIG. 6 is a cross sectional view showing a state of a locking apparatus being disengaged, and FIG. 7 is a cross sectional view of a main portion showing a state of the engagement apparatus being returned to an initial position.

In FIGS. 1 and 2, reference numeral 30 denotes a truck with a hoist, and reference numeral 31 denotes a frame thereof. The frame 31 is formed in a fork shape with an open front portion, by a pair of side portion frames 32 and 32, which are apart from each other at the right and the left, and a cross frame 33 coupled to rear portions thereof (a right portion in FIG. 2), front wheels 34 and 34 are attached to front portions of the respective side portion frames 32 and 32, and rear wheels (casters) 35 and 35 and a handle 36 for steering the truck are attached to rear portions of the respective side portion frames 32 and 32. The cross frame 33 is structured, as shown in FIG. 2, such that an interval between the respective side portion frames 32 and 32 can be adjusted by slidably fitting a large-diameter tube 33a and a small-diameter tube 33b firmly fixed to the respective side portion frames 32 and 32, and fastening both the elements by a bolt 33c.

A hoist table 40 is mounted to the frame 31 so as to be movable upward and downward. The hoist table 40 is constituted by side portion hoist tables 41 fitted to the respective side portion frames 32 and 32 from the above, and a rear portion hoist table 42 coupled to a rear portion thereof (a right portion in FIG. 2), and the respective side portion hoist tables 41 are formed in an inverted-U shape in a cross section and cover upper surfaces and both right and left sides of the respective side portion frames 32 and 32, and have holders 41a and 41a protruding in opposing directions to each other at lower ends of inner side walls thereof. The rear portion hoist table 42 is structured such that an interval between the respective side portion hoist tables 41 and 41 can be adjusted in correspondence to a magnitude (a width) of the box container by slidably fitting inverted-L shaped steel plates 42a and 42b, which are firmly fixed to the respective side portion hoist tables 41 and 41, to each other and fastening both the elements by the bolt 42c.

An actuating apparatus 45 is provided between the respective side portion frames 32 and 32 and the respective side portion hoist tables 41 and 41. The actuating apparatus 45 has a parallel link mechanism 46 making the hoist table 40 in a horizontal state and moving the hoist table 40 upward and downward with respect to the frame 31, and a locking apparatus 50 holding and releasing the lifted hoist table 40. The parallel link mechanism 46 is structured, as shown in FIG. 3, such that front portion link arms 47a and rear portion link arms 47b are arranged in a front portion and a rear portion of the respective side portion frames 32 and 32 and the respective side portion hoist tables 41 and 41 so as to be directed in the same longitudinal direction, front ends thereof are rotatably connected to the respective side portion hoist tables 41 and 41 by front portion pins P1 and P1, and rear ends thereof are rotatably connected to the respective side portion frames 32 and 32 by rear portion pins P2 and P2.

Actuating levers 48 and 48 are integrally connected to rear ends of the respective rear portion link arms 47b. The respective actuating levers 48 and 48 are extended rearward and upward as shown in FIGS. 1 and 3, and rear ends thereof are connected to each other by a step bar 48a. A user rotates the rear portion link arms 47b upward at an angle of about 45 degree around the rear portion pins P2 by stepping on the step bar 48a, thereby, actuating the parallel link mechanism 46 to an ascending side and moving the hoist table 40 upward in parallel with respect to the frame 2 so as to lift holders 41a thereof from a ground surface.

A locking apparatus 50 is structured, as shown in FIG. 3, such that engagement arms 51 are extended frontward (a left side in FIG. 3) so as to be rotatably connected to the front portion pins P1 of the respective rear portion link arms 47b, and cylindrical engagement bodies 52 are attached to front ends of the engagement arms 51. The engagement arms 51 are rotated downward on the basis of a dead weight thereof. Further, plates 53 are fixed to the side surfaces of the respective side portion frames 2a and in the middle of loca of the engagement bodies 52 moving in accordance with the rotation of the rear portion link arms 47b, and annular guide grooves 54 guiding the engagement bodies 52 in a longitudinal direction and a vertical direction are formed in the plates 53.

The guide grooves 54 are structured, as shown in FIGS. 3 to 7, such that lower portions of the guide grooves 54 are extended out in a longitudinal direction (to the right and left in FIG. 3), and front portion bottom walls 54a thereof are inclined upward and frontward. Further, upper portions of the guide groove 54 are bent in a downward step shape in rear half portions, front walls of the step portions are formed in a rearward circular arc shape so as to be formed as front portion stopper walls 54b, and a rear walls of the step portions are formed in a forward circular arc shape so as to be formed as rear portion stopper walls 54c.

Further, a plate check valves 55 are rotatably supported by pins to front portion sides of the guide grooves 54 so as to be inclined downward and frontward, and lower ends of the check valves 55 are brought into contact with the front portion bottom walls 54a. The check valves 55 are rotated downward on the basis of a dead weight thereof so as to bring a lower ends thereof into contact with the front portion bottom walls 54a.

In accordance with the embodiment mentioned above, at an initial time when the parallel link mechanism 46 is actuated to the descending side on the basis of the dead weight of the hoist table 40, the engagement arms 51 of the locking apparatus 50 is pushed forward by upper end portions of the rear portion link arms 47b of the parallel link mechanism 46, and the engagement bodies 52 open the check valves 55 so as to pass through these portions as shown in FIG. 3, and thereafter move to the front end side of the guide grooves 54, and the check valves 55 are thereafter in a closed state on the basis of the dead weight thereof.

In this state, as shown in FIG. 1, when the hoist table 40 is positioned in a lower surface side of a box container 25-1 having a flange 25a in a lower portion or a box container 25-2 having a leg 25b in a lower portion, and the parallel link mechanism 46 is actuated to an ascending side by stepping down the actuating lever 48, the hoist table 40 is moved upward from the frame 31 so as to lift the box container 25-1 or 25-2 from the ground surface. In this case, in the box container 25-1 having the flange 25a in the lower portion, the box container 25-1 is lifted by engaging the holders 41a of the hoist table 40 with the flange 25a, and in the box container 25-2 having the leg 25b, the box container 25-2 is lifted by engaging the upper surfaces of the side portion hoist tables 41 with the bottom surface of the box container 25-2.

The engagement arms 51 of the locking apparatus 50 are pulled rearward by an upper end portions of the rear portion link arms 47b in accordance with the operation of the parallel link mechanism 46 to the ascending side, and the engagement bodies 52 are guided to the upper portion side of the guide grooves 54 along the upper surfaces of the check valves 55 and thereafter come into collision with (is engaged with) the rear portion stopper walls 54c formed in the upper portion side, as shown in FIG. 4, whereby the downward rotation of the actuating levers 48 is inhibited.

Next, when releasing the stepping down of the actuating levers 48, the hoist table 40 comes down on the basis of the weight of the box container 25-1, whereby the parallel link mechanism 46 is going to be actuated in a descending direction, however, the engagement bodies 52 come down to the step portions of the guide grooves 54 at this time, and come into collision with (is engaged with) the front walls of the step portions, that is, the front portion stopper walls 54b so as to inhibit the parallel link mechanism 46 from being actuated downward. Accordingly, it is possible to inhibit the hoist table 40 from descending, it is possible to keep a state of the box container 25-1 being lifted from the ground surface, and it is possible to move the box container 25-1 to an optional place by the truck 30 (a state in FIG. 5).

Next, the engagement bodies 52 is disengaged from the front portion stopper walls 54b by stepping down the actuating levers 48 so as to actuate the parallel link mechanism 46 further to the ascending side, at a time of unloading the box container 25-1 from the truck 30, and the engagement bodies 52 come down to the front portion side lower portions of the guide grooves 54 on the basis of the dead weight. When stopping the stepping down of the actuating levers 48 in this state, the parallel link mechanism 46 is actuated in the descending direction on the basis of the weights of the box container 25-1 and the hoist table 40, whereby the engagement bodies 52 are moved forward in the lower portion side of the guide grooves 54, and move to the front end side of the guide grooves 54 after opening the check valves 55 so as to pass through these portions. Thereafter, the check valves 55 are closed on the basis of the dead weight so as to be in the initial state as shown in FIGS. 7 and 3, and the box container 25-1 is grounded, whereby it is possible to easily remove the truck 30 from the box container 25-1.

Accordingly, since the locking apparatus in accordance with the present invention does not use any spring, the durability of the locking apparatus is enhanced and an assembly can be easily executed.

What is claimed is:

1. A locking apparatus of a truck with a hoist comprising a fork-shaped frame made by connecting rear end portions of a pair of side portion frames apart from each other at the right and the left via a cross frame and provided with wheels in lower portions, a hoist table covering at least inner sides and upper surfaces of said respective side portion frames, and an actuating apparatus provided with a parallel link mechanism holding the hoist table horizontally and moving the hoist table upward and downward with respect to the frame, actuating levers actuating said parallel link mechanism, and a locking apparatus holding and releasing an ascended position of said hoist table, so as to move said hoist table upward and downward with respect to the frame, wherein the locking apparatus has engagement arms connected to an upper end portions of link arms, which are connected to hoist table side of the parallel link mechanism, so as to freely oscillate frontward, engagement bodies provided in front end portions of said engagement arms, annular guide grooves provided in said side portion frames, to guide said engagement bodies in a longitudinal direction and a vertical direction stopper walls provided in upper portions of said guide grooves, and having rear portions extended downward in a step shape and check valves provided in front portions of the guide grooves to allow said engagement bodies to pass through forward and guide said passed engagement bodies to upper portion side of the guide grooves.

2. A locking apparatus of a truck with a hoist as claimed in claim 1, wherein said guide grooves are formed in independent plates from the side portion frames, and said plates are fixed to side surfaces of said side portion frames.
